(19) United States
(12) Patent Application Publication
(10) Pub. No.: US 2024/0086727 A1
(43) Pub. Date: Mar. 14, 2024

(54) Automatically Building Efficient Machine Learning Model Training Environments

(71) Applicant: International Business Machines Corporation, Armonk, NY (US)

(72) Inventors: Yao Dong Liu, XI'AN (CN); Dong Hai Yu, XI'AN (CN); Jiang Bo Kang, XI'AN (CN); Bo Song, XI'AN (CN); Jun Wang, XI'AN (CN)

(21) Appl. No.: 17/930,835

(22) Filed: Sep. 9, 2022

(51) Int. Cl. G06N 5/02

(52) U.S. Cl. CPC G06N 5/022

(57) ABSTRACT

Machine learning model training is provided. A model training result of a machine learning model is predicted utilizing a classification model based on a plurality of different combinations of input data set properties, settings of the machine learning model, and machine learning model training environment properties. Model training duration of the machine learning model is predicted utilizing a regression model based on those combinations that had a predicted successful model training result. Capacity unit hours is determined for each respective combination having the predicted successful model training result based on a corresponding predicted model training duration of the machine learning model. A particular combination of input data set properties, settings of the machine learning model, and machine learning model training environment properties that has minimum capacity unit hours is selected. The machine learning model is trained using the particular combination.

### BACKGROUND

### 1. Field

The disclosure relates generally to machine learning model training and more specifically to automatically building an efficient machine learning model training environment runtime in a cloud.

### 2. Description of the Related Art

Machine learning is a field devoted to building models that “learn,” that is, models that leverage data to improve performance on some set of tasks. Machine learning algorithms build a model based on sample data, known as training data, in order to make predictions or decisions without being explicitly programmed to do so. Machine learning models are used in a wide variety of applications, such as in email filtering, speech recognition, computer vision, disease diagnosis, and the like where it is difficult to develop conventional models to perform needed tasks.

Training a machine learning model is a process in which a machine learning algorithm is fed with training data from which it can learn. Machine learning models can be trained to quickly process large volumes of data to identify patterns, find anomalies, test correlations, and the like that would be difficult for a human to do unaided. Machine learning model training results in a working machine learning model that can then be deployed. The machine learning model's performance during training will determine how well the model will work when the model is incorporated into an application for end-user use.

### SUMMARY

According to one illustrative embodiment, a computer-implemented method is provided. A computer predicts a model training result of a machine learning model utilizing a classification model based on a plurality of different combinations of input data set properties, settings of the machine learning model, and machine learning model training environment properties. The computer predicts model training duration of the machine learning model utilizing a regression model based on only those combinations of input data set properties, settings of the machine learning model, and machine learning model training environment properties that had a predicted successful model training result by the classification model. The computer determines capacity unit hours for each respective combination of input data set properties, settings of the machine learning model, and machine learning model training environment properties having the predicted successful model training result based on a corresponding predicted model training duration of the machine learning model. The computer selects a particular combination of input data set properties, settings of the machine learning model, and machine learning model training environment properties that has determined minimum capacity unit hours. The computer trains the machine learning model using the particular combination of input data set properties, settings of the machine learning model, and machine learning model training environment properties that has the determined minimum capacity unit hours. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIGS. 2A-2B are a diagram illustrating an example of a model training environment building process in accordance with an illustrative embodiment;

FIG. 3 is a diagram illustrating an example of a model training result table in accordance with an illustrative embodiment;

FIG. 4 is a diagram illustrating an example of a model training duration table in accordance with an illustrative embodiment;

FIG. 5 is a diagram illustrating an example of a model training capacity unit hours (CUH) table in accordance with an illustrative embodiment;

FIG. 6 is a flowchart illustrating a process for training a machine learning model in accordance with an illustrative embodiment; and

FIGS. 7A-7D are a flowchart illustrating a process for automatically building a machine leaning model training environment runtime in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

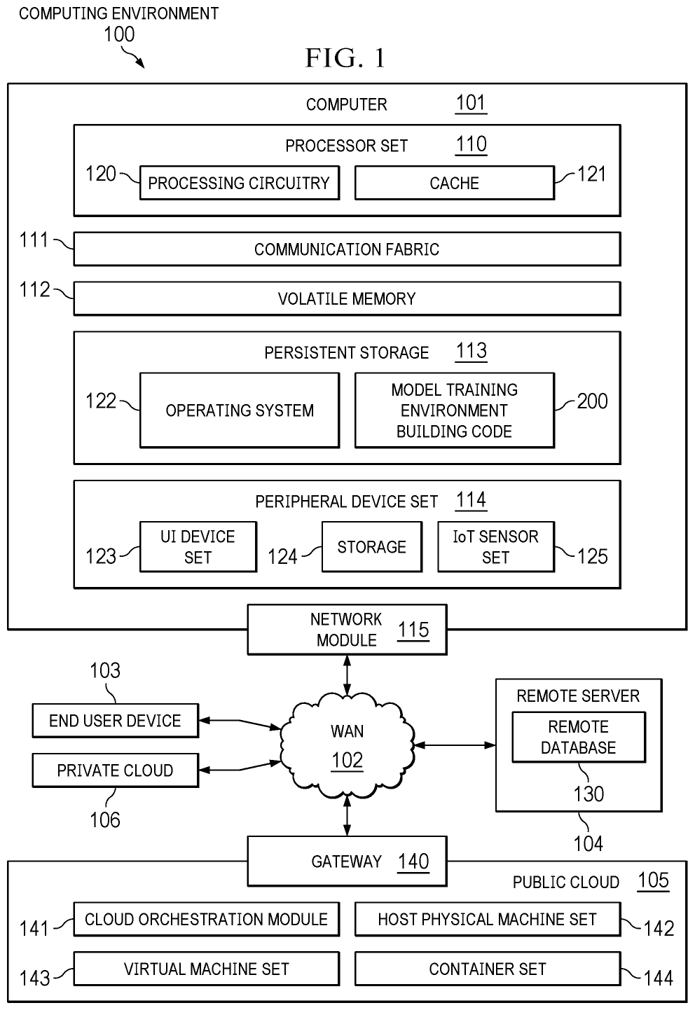

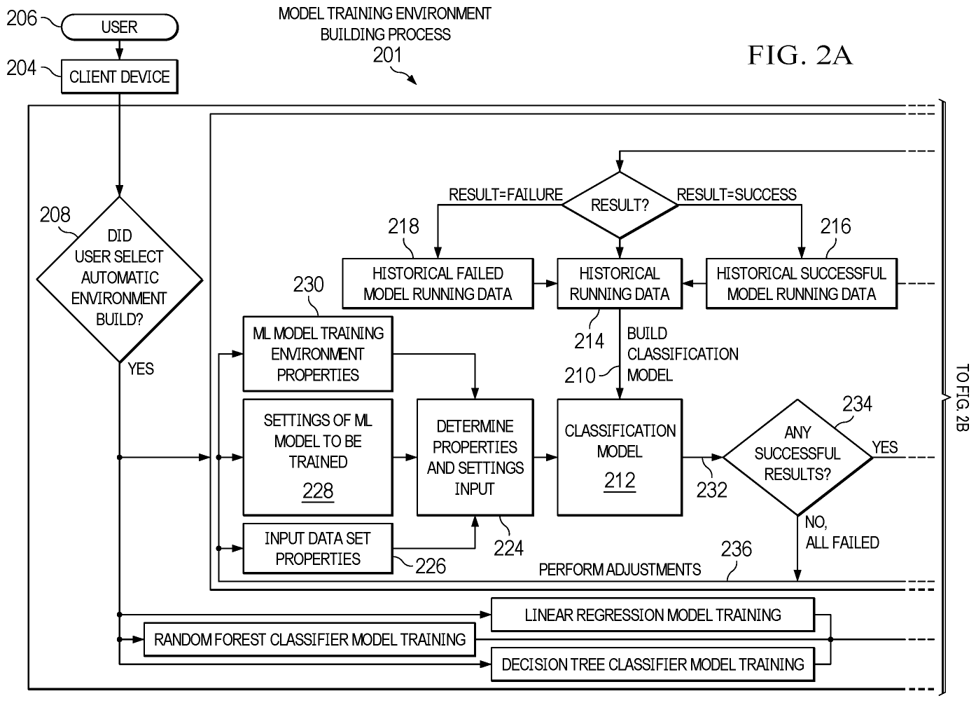

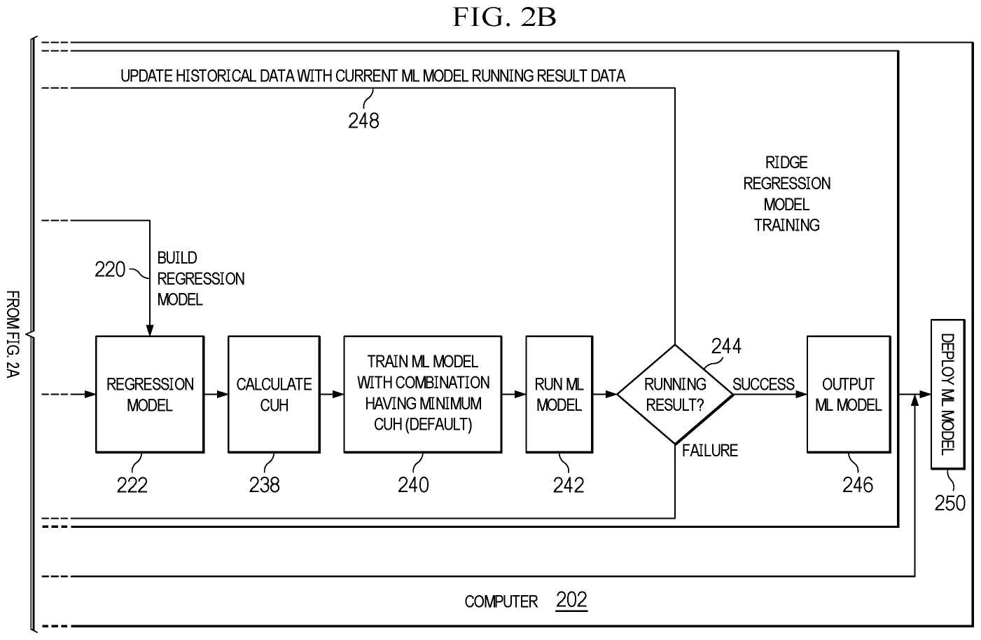

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as model training environment building code 200. For example, model training environment building code 200 builds a set of prediction models (e.g., a classification model and a regression model) using input features, such as, for example: historical machine learning model training environment resource properties, such as, for example, number of nodes, number of central processing units (CPUs), memory size, disk size, disk type, file size, file type, and the like; historical input data set properties, such as, for example, row number, column number, categorical number, and the like; and historical model settings of the machine learning model to be trained, such as, for example, model name, model type, maximum tree depth, and the like. Then, when running a training job on that particular machine learning model, model training environment building code 200 utilizes these prediction models to predict in advance whether the machine learning model can be trained successfully or not. In response to predicting that the machine learning model cannot be successfully trained due to lack of machine learning model training environment runtime resources, such as, for example, out-of-memory (00M), which model training environment building code 200 predicted to occur in advance, model training environment building code 200 automatically recommends a set of adjustments to the user, such as, for example, decrease the size of the input data set, change the settings of the machine learning model, and/or change the machine learning model training environment runtime resource size. Alternatively, model training environment building code 200 automatically implements the recommended set of adjustments by performing at least one of decreasing the size of the input data set, changing the settings of the machine learning model, or changing the machine learning model training environment runtime resource size (e.g., number or amount of resources) based on the results of the prediction models. Afterward, model training environment building code 200 automatically reruns the machine learning model training job after implementing the set of adjustments. As a result, model training environment building code 200 is capable of successfully training any machine learning model. Further, model training environment building code 200 collects and utilizes the running results of machine learning model training jobs to increase the predictive accuracy of the prediction models over time.

In addition to model training environment building code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model training environment building code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in model training environment building code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The model training environment building code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Typically, a user manually selects a size of the machine learning model training environment runtime (e.g., amount of cloud resources needed such as number of nodes, number of CPUs, memory size, storage size, and the like) prior to running a training job of a machine learning model (e.g., for a data science-related application). However, machine learning model training is not always successful.

For example, sometimes a machine learning model training job fails after an extended period of time due to, for example, OOM, lack of storage space, high CPU usage, or the like, especially for big data. Generally, it takes the user a long time to determine that the machine learning model training job failed due to lack of training environment resources. As a result of the machine learning model training job failure, the user needs to select a new size of the machine learning model training environment and then rerun the model training one or more times until successful model training is achieved. Rerunning machine learning model training is time consuming, resource consuming, and cost consuming for the user and the cloud environment. For example, the user is charged for the resources used by the machine learning model training environment runtime in the cloud based on, for example, capacity unit hours (CUH). The number of CUH calculates resource usage consumed by an active cloud environment runtime.

Consequently, determining an efficient and appropriate size of the machine learning model training runtime is needed for both the user and the cloud environment. In addition, settings of the machine learning model during training and size of the input data set may also result in failure due to lack of machine learning model training environment runtime resources. As a result, determining appropriate settings of the machine learning model or size of the input data set during training is also needed.

To address these issues, illustrative embodiments provide a process that avoids machine learning model training job failures due to lack of machine learning model training environment runtime resources in advance by predicting whether results of machine learning model training is successful or not, which saves time, resources, and money for both the user and the cloud environment.

Illustrative embodiments build and run both a classification model and a regression model using historical data of previous machine learning model training jobs in the cloud environment, including different combinations of input data properties, machine learning model training environment properties, and machine learning model settings during machine learning model training. Illustrative embodiments predict the result of a particular machine learning training job using the classification model with different combinations of input data set properties, machine learning model training environment properties, and machine learning model settings as input in advance of (i.e., prior to) training that particular machine learning model. The result generated by the classification model is a categorical field that includes a value, such as, for example, Success, OOM, HighCPU, DiskFull, or the like.

Afterward, illustrative embodiments utilize the regression model to predict the duration (e.g., in hours, minutes, seconds, or the like) of the machine learning model training job based on each combination of input data properties, machine learning model training environment properties, and machine learning model settings having a predicted result of Success by the classification model. Illustrative embodiments utilize the predicted duration of the machine learning training job corresponding to each combination to determine the CUH of each respective combination. Illustrative embodiments run the machine learning training job utilizing the user preferred-combination that produces the minimum CUH, minimum training environment size, or minimum model training duration time. It should be noted that illustrative utilize the combination having the minimum CUH to run the machine learning training job by default when no user preference is received. Illustrative embodiments rebuild the classification model and the regression model used to make the model training result prediction and the model training duration prediction, respectively, using the data of the most recent running result of the machine learning model training job to increase prediction accuracy of the classification and regression models.

Illustrative embodiments build a classification model using all historical machine learning model running data after both successful and failed machine learning model training jobs corresponding to the different combinations of input data properties, machine learning model training environment properties, and machine learning model settings during machine learning model training in a machine learning model training runtime of a cloud environment. It should be noted that illustrative embodiments build a classification model for each respective machine learning model of a set of machine learning models to be trained. The categorical value of the classification model result is one of Success indicating a successful machine learning model training job, OOM indicating a machine learning model training job failure due to lack of memory, HighCPU indicating machine learning model training job failure due to continual running of the CPU without finishing the model training job, and DiskFull indicating machine learning model training job failure due to lack of storage space.

Illustrative embodiments build a regression model using historical machine learning model running data for only successful machine learning model training jobs corresponding to the different combinations of input data properties, machine learning model training environment properties, and machine learning model settings during machine learning model training in a machine learning model training runtime of the cloud environment. In other words, unlike the classification model that utilizes both successful and failed machine learning model training job data, the regression model uses historical data from only successful machine learning model training jobs. It should be noted that illustrative embodiments build a regression model for each respective machine learning model of the set of machine learning models to be trained.

Illustrative embodiments can also receive an input from the user to enable illustrative embodiments to automatically recommend and build an efficient machine learning model training environment runtime. In response to illustrative embodiments receiving the input from the user enabling automatic build of an efficient machine learning model training environment runtime, illustrative embodiments determine the combination of input data properties, machine learning model training environment properties, and machine learning model settings that produces the minimum CUH, the minimum environment size, or the minimum model training duration, which is preferred by the user, to train the machine learning model. In addition, in response to no predicted successful results being returned by the classification model, the user can optionally elect to have illustrative embodiments decrease the size of the input data set (e.g., 30% of the latest or most recent input data set) to train the machine learning model.

Further, illustrative embodiments collect the data of the current machine learning model training job and add that data to the historical data for rebuilding, tuning, or adjusting the classification model and the regression model to improve predictive accuracy of model training results and model training durations, respectively. The collected data of the current machine learning model training job includes the specific input data properties, machine learning model training environment properties, and machine learning model settings that illustrative embodiments utilized to run the current machine learning model training job.

The input data set properties that illustrative embodiments utilize to train the machine learning model include, for example, row or record number, column or field number, file size, file type, categorical field number, average categorical field value number, continuous field number, and the like. It should be noted that illustrative embodiment can also utilize other input data set properties that have an impact on machine learning model training environment runtime performance not listed above.

The machine learning model training environment runtime properties (e.g., environment size) that illustrative embodiments utilize to train the machine learning model include, for example, pod CPU core number, pod memory size (e.g., gigabytes), cluster controller node CPU core number, cluster controller node memory size, cluster worker node CPU core number, cluster worker node memory size, cluster worker node number, and the like. It should be noted that illustrative embodiments generate a new machine learning model training environment runtime for each respective model training job. Consequently, illustrative embodiments assume that sufficient resources are available for each machine learning model training environment runtime size. Also, illustrative embodiments may also utilize other machine learning model training environment properties, such as, for example, software version, library dependencies, and the like.

The machine learning model settings that illustrative embodiments utilize include, for example, number of estimators, maximum tree depth, minimum samples to split, model number, sub-model number, and the like. It should be noted that settings are different for each respective machine learning model to be trained. As a result, illustrative embodiments build a new classification model and a new regression model for each respective machine learning model to be trained.

Thus, illustrative embodiments automatically build an efficient machine learning model training runtime in a cloud environment based on predictions of the classification model and the regression model using historical machine learning model running data after training to enable illustrative embodiments to decrease time, resource, and cost consumption for the user and the cloud environment. Therefore, illustrative embodiments increase the efficiency and performance of machine learning model training environments.

Thus, illustrative embodiments provide one or more technical solutions that overcome a technical problem with automatically building an efficient machine learning model training environment runtime. As a result, these one or more technical solutions provide a technical effect and practical application in the field of machine learning model training.

With reference now to FIGS. 2A-2B, a diagram illustrating an example of a model training environment building process is depicted in accordance with an illustrative embodiment. Model training environment building process 201 may be implemented in a computing environment, such as computing environment 100 in FIG. 1. Model training environment building process 201 utilizes hardware and software components for automatically building an efficient machine learning model training environment runtime in a cloud.

In this example, model training environment building process 201 includes computer 202 and client device 204. Computer 202 and client device 204 may be, for example, computer 101 and end user device (EUD) 103, respectively, in FIG. 1. However, it should be noted that model training environment building process 201 is intended as an example only and not as a limitation on illustrative embodiments. In other words, model training environment building process 201 can include any number of computers, client devices, and other components not shown.

User 206 utilizes client device 204 to send an input to computer 202 to initiate training of a set of machine learning models. The set of machine learning models may include, for example, a ridge regression model, a linear regression model, a random forest classifier model, a decision tree classifier model, and the like. However, it should be noted that computer 202 can train any number and type of machine learning models.

In response to receiving the input, computer 202 selects a machine leaning model (e.g., the ridge regression model) from the set for training. In addition, at 208, computer 202 determines whether user 206 selected automatic machine learning model training environment build. If user 206 did not select automatic machine learning model training environment build, then computer 202 trains the machine learning model using a standard machine learning model training process. Conversely, if user 206 did select automatic machine learning model training environment build, then computer 202 trains the machine learning model using the machine learning model training process of illustrative embodiments.

For example, if user 206 selected automatic machine learning model training environment build, then, at 210, computer 202 builds classification model 212 specifically for that particular machine learning model (e.g., the ridge regression model). Computer 202 builds classification model 212 using historical running data 214, which includes both historical successful model running data 216 and historical failed model running data 218 corresponding to that particular machine learning model to be trained. In addition, at 220, computer 202 builds regression model 222 for that particular machine learning model using only historical successful model running data 216 corresponding to that particular machine learning model.

Further, at 224, computer 202 determines properties and settings input for classification model 212. The properties and settings input includes input data set properties 226, settings of that particular machine learning model to be trained 228, and machine learning model training environment properties 230. Computer 202 inputs a plurality of different combinations of input data set properties 226, settings of that particular machine learning model to be trained 228, and machine learning model training environment properties 230 into classification model 212 for processing.

At 232, computer 202 runs classification model 212 with the plurality of different combinations of input data set properties 226, settings of that particular machine learning model to be trained 228, and machine learning model training environment properties 230 to predict training results of that particular machine learning model. At 234, computer 202 determines whether classification model 212 returned any predicted successful model training results for that particular machine learning model.

If classification model 212 did not return any predicted successful model training results for that particular machine learning model, then computer 202 automatically performs a set of adjustments on at least one of input data set properties 226, settings of that particular machine learning model to be trained 228, or machine learning model training environment properties 230 and reruns classification model 212 with the set of adjustments. Conversely, if classification model 212 did return one or more predicted successful model training results for that particular machine learning model, then computer 202 selects only those combinations of input data set properties 226, settings of that particular machine learning model to be trained 228, and machine learning model training environment properties 230 which produced a predicted successful model training result for that particular machine learning model.

Afterward, computer 202 runs regression model 222 with only those combinations of input data set properties 226, settings of that particular machine learning model to be trained 228, and machine learning model training environment properties 230, which produced a predicted successful model training result for that particular machine learning model, to predict a model training duration for that particular machine learning model. At 238, computer 202 calculates CUH for each respective combination producing a predicted successful model training result based on the predicted model training duration of that particular combination.

At 240, computer 202 trains that particular machine learning model using the combination of input data set properties 226, settings of that particular machine learning model to be trained 228, and machine learning model training environment properties 230 that has the minimum or lowest CUH. At 242, computer 202 runs that particular machine learning model, which was trained with the combination of input data set properties 226, settings of that particular machine learning model to be trained 228, and machine learning model training environment properties 230 having the minimum CUH. At 244, computer 202 determines a running result of that particular machine learning model after being trained.

If computer 202 determines that the running result of that particular machine learning model after being trained was a failure, then computer 202 performs a set of adjustments on at least one of input data set properties 226, settings of that particular machine learning model to be trained 228, and machine learning model training environment properties 230. Conversely, if computer 202 determines that the running result of that particular machine learning model after being trained was successful, then, at 246, computer 202 outputs that particular machine learning model as successfully trained. In addition, at 248, computer 202 updates historical running data 214 with data corresponding to the current running of that particular machine learning model whether running result success or running result failure.

Subsequently, at 250, computer 202 deploys that particular machine learning model as being successfully trained. Further, computer 202 selects another machine learning model (e.g., the linear regression model) in the set of machine learning models to be trained and performs the machine learning model training process of illustrative embodiments above once again. Upon completion of that training process, then computer 202 selects the next machine learning model in the set, and so on.

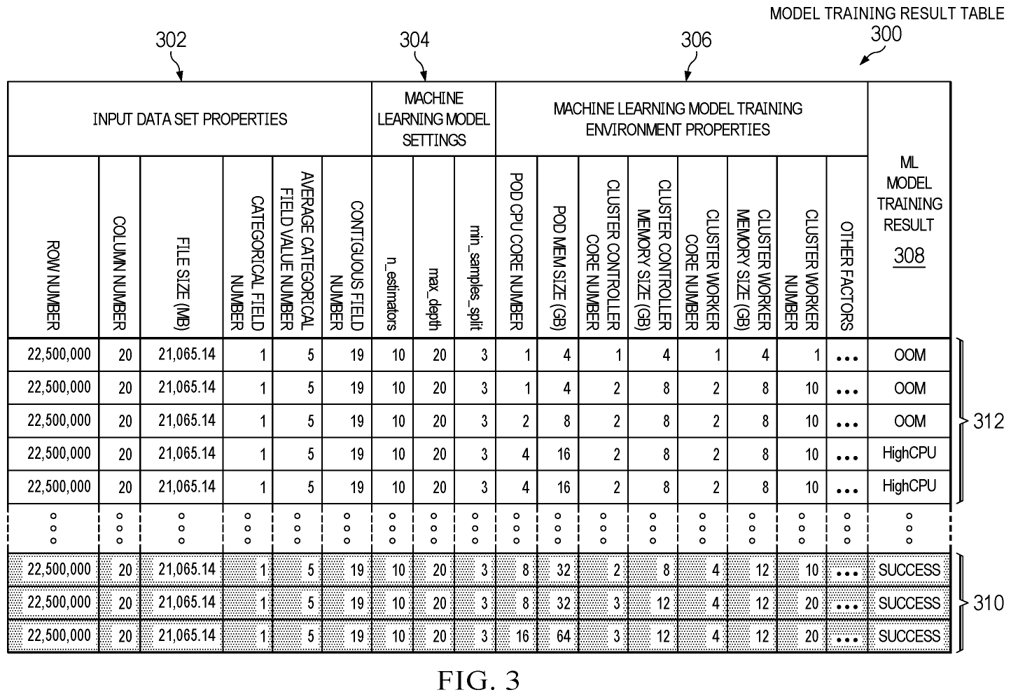

With reference now to FIG. 3, a diagram illustrating an example of a model training result table is depicted in accordance with an illustrative embodiment. Model training result table 300 may be implemented in a computer, such as, for example, computer 101 in FIG. 1 or computer 202 in FIGS. 2A-2B. Model training result table 300 includes input data set properties 302, machine learning model settings 304, machine learning model training environment properties 306, and machine learning model training result 308.

The computer utilizes a classification model to predict machine learning model training result 308 based on different combinations of input data set properties 302, machine learning model settings 304, and machine learning model training environment properties 306. The classification model may be, for example, classification model 212 in FIGS. 2A-2B. Only when the classification model returns a predicted result of Success (e.g., successful model training results 310), the computer selects those corresponding combinations of input data set properties 302, machine learning model settings 304, and machine learning model training environment properties 306 as input to a regression model for predicting machine learning model training duration for each respective combination having a predicted successful model training result. The regression model may be, for example, regression model 222 in FIGS. 2A-2B. The computer records those combinations of input data set properties 302, machine learning model settings 304, and machine learning model training environment properties 306 that resulted in machine learning model training failure (e.g., failed model training results 312) for user review.

Further, when the classification model predicts that no combination of input data set properties 302, machine learning model settings 304, and machine learning model training environment properties 306 result in a successful machine learning model training result, the computer at least one of adjusts one or more of machine learning model settings 304 or adjusts one or more of machine learning model training environment properties 306 and then reruns the machine learning model training job. If the classification model once again does not return a successful machine learning model training result, then the computer can optionally request the user to provide a percentage amount (e.g., 30%) that the computer can reduce the input data set size by to train the machine learning model. It should be noted that 30% is intended as an example only and not as a limitation on illustrative embodiments. In other words, the computer can reduce the size of the input data set by any amount (e.g., 5%, 10%, 15%, 20%, 25%, or the like). Alternatively, the computer can automatically determine the percentage amount to reduce the size of the input data set.

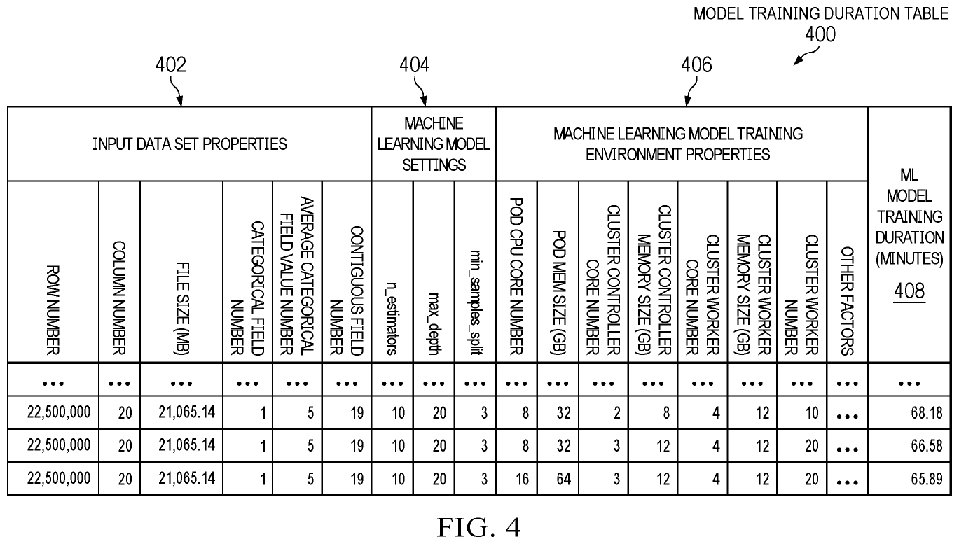

With reference now to FIG. 4, a diagram illustrating an example of a model training duration table is depicted in accordance with an illustrative embodiment. Model training duration table 400 may be implemented in a computer, such as, for example, computer 101 in FIG. 1 or computer 202 in FIGS. 2A-2B. Model training duration table 400 includes input data set properties 402, machine learning model settings 404, machine learning model training environment properties 406, and machine learning model training duration 408. Input data set properties 402, machine learning model settings 404, and machine learning model training environment properties 406 may be, for example, input data set properties 302, machine learning model settings 304, and machine learning model training environment properties 306 in FIG. 3. The computer utilizes a regression model to predict machine learning model training duration 408 based on only those combinations of input data set properties 402, machine learning model settings 404, and machine learning model training environment properties 406 that have a predicted successful machine learning model training result by the classification model (e.g., successful model training results 310 of FIG. 3).

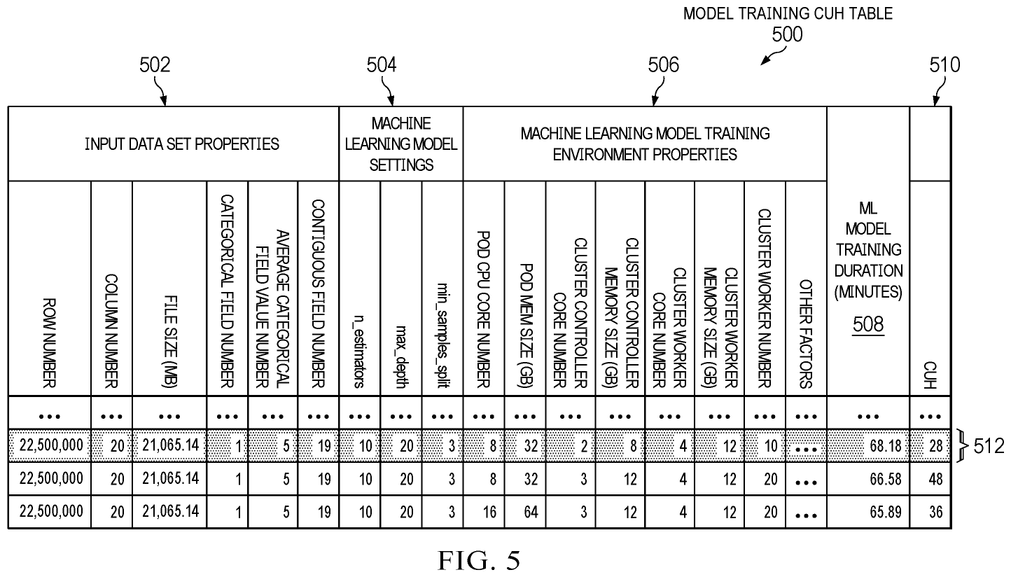

With reference now to FIG. 5, a diagram illustrating an example of a model training CUH table is depicted in accordance with an illustrative embodiment. Model training CUH table 500 may be implemented in a computer, such as, for example, computer 101 in FIG. 1 or computer 202 in FIGS. 2A-2B. Model training CUH table 500 includes input data set properties 502, machine learning model settings 504, machine learning model training environment properties 506, machine learning model training duration 508, and CUH 510. Input data set properties 502, machine learning model settings 504, machine learning model training environment properties 506, and machine learning model training duration 508 may be, for example, input data set properties 402, machine learning model settings 404, machine learning model training environment properties 406, and machine learning model training duration 408 in FIG. 4.

The computer receives from the user a preference as to whether the user prefers the combination that produces the minimum CUH, the minimum model training environment size, or the minimum model training duration. If no user preference is received, then by default the computer selects the combination of input data set properties 502, machine learning model settings 504, and machine learning model training environment properties 506 that produces the minimum CUH to run the machine learning model training job. In this example, combination 512 is the combination of input data set properties 502, machine learning model settings 504, and machine learning model training environment properties 506 that produces the minimum CUH. It should be noted that the CUH values in model training CUH table 500 are meant as examples of estimated CUH values only and not as actual CUH values.

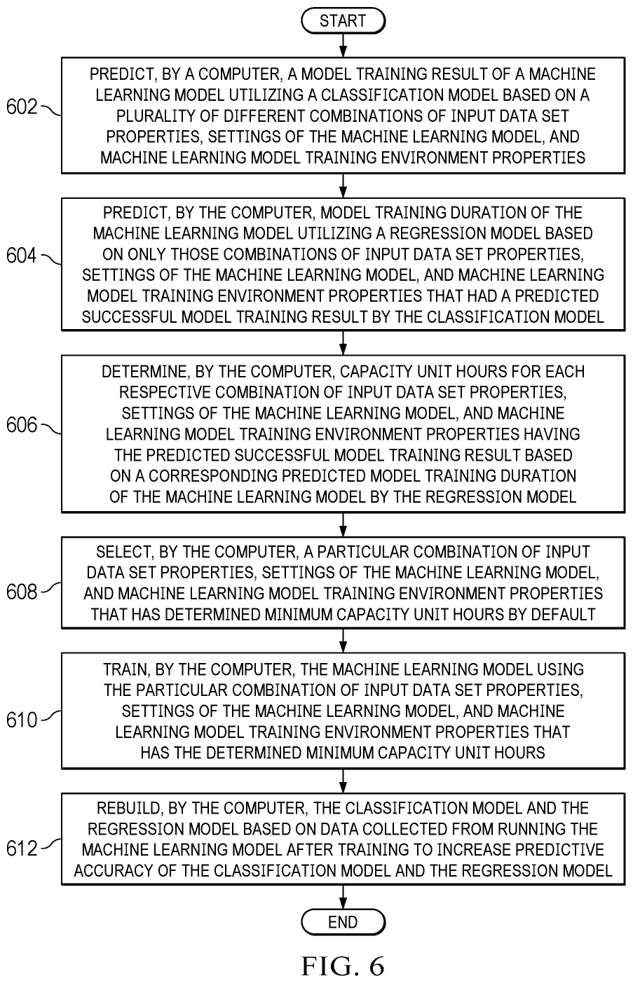

With reference now to FIG. 6, a flowchart illustrating a process for training a machine learning model is shown in accordance with an illustrative embodiment. The process shown in FIG. 6 may be implemented in a computer, such as, for example, computer 101 in FIG. 1 or computer 202 in FIGS. 2A-2B. For example, the process shown in FIG. 6 may be implemented in model training environment building code 200 in FIG. 1.

The process begins when the computer predicts a model training result of a machine learning model utilizing a classification model based on a plurality of different combinations of input data set properties, settings of the machine learning model, and machine learning model training environment properties (step 602). In addition, the computer predicts model training duration of the machine learning model utilizing a regression model based on only those combinations of input data set properties, settings of the machine learning model, and machine learning model training environment properties that had a predicted successful model training result by the classification model (step 604).

The computer determines capacity unit hours for each respective combination of input data set properties, settings of the machine learning model, and machine learning model training environment properties having the predicted successful model training result based on a corresponding predicted model training duration of the machine learning model (step 606). The computer selects a particular combination of input data set properties, settings of the machine learning model, and machine learning model training environment properties that has determined minimum capacity unit hours by default (step 608).

The computer trains the machine learning model using the particular combination of input data set properties, settings of the machine learning model, and machine learning model training environment properties that has the determined minimum capacity unit hours (step 610). The computer rebuilds the classification model and the regression model based on data collected from running the machine learning model after training to increase predictive accuracy of the classification model and the regression model (step 612). Thereafter, the process terminates.

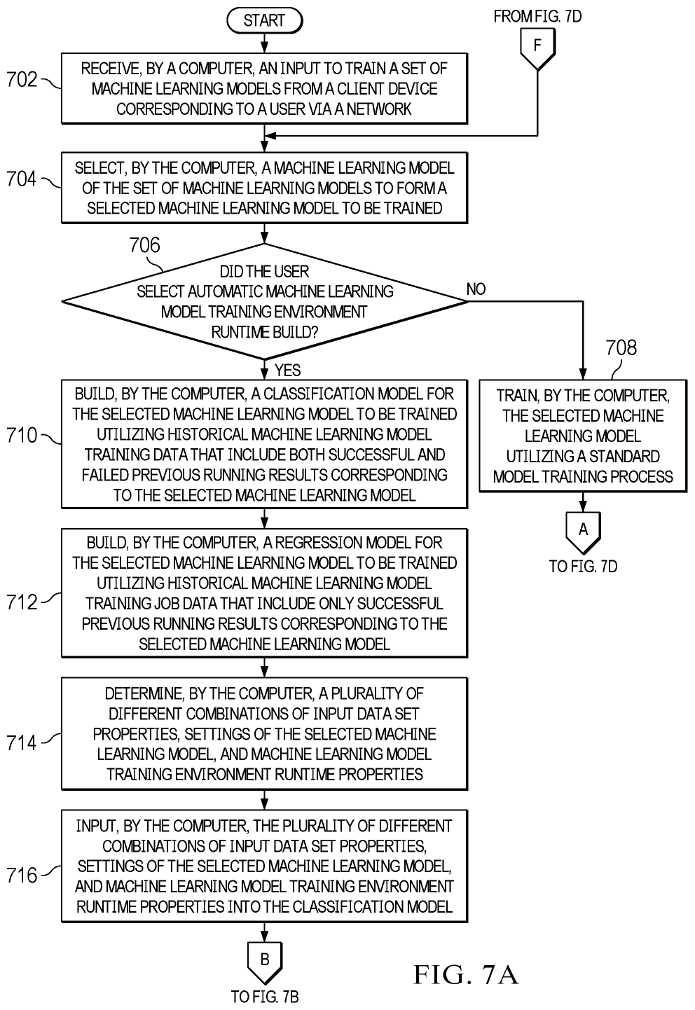

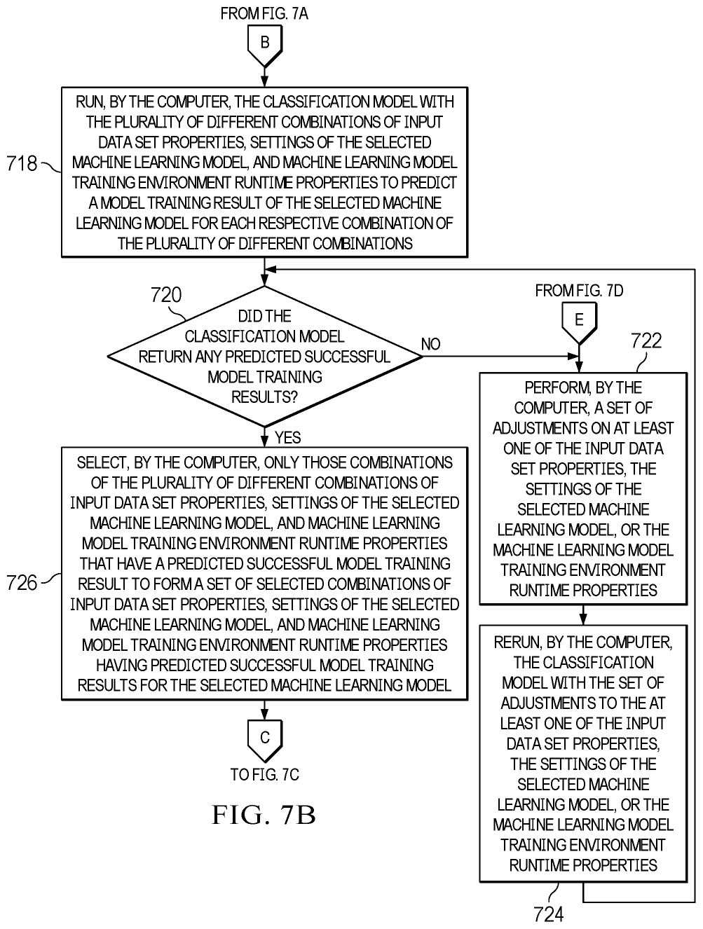

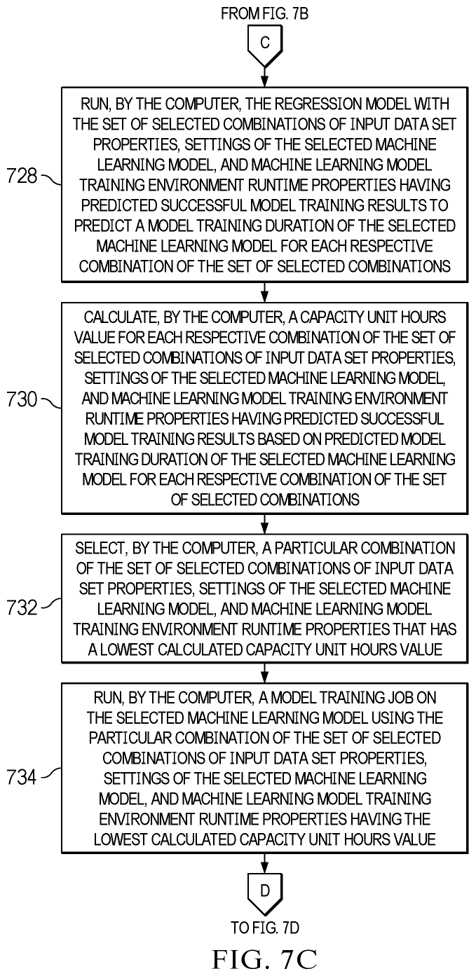

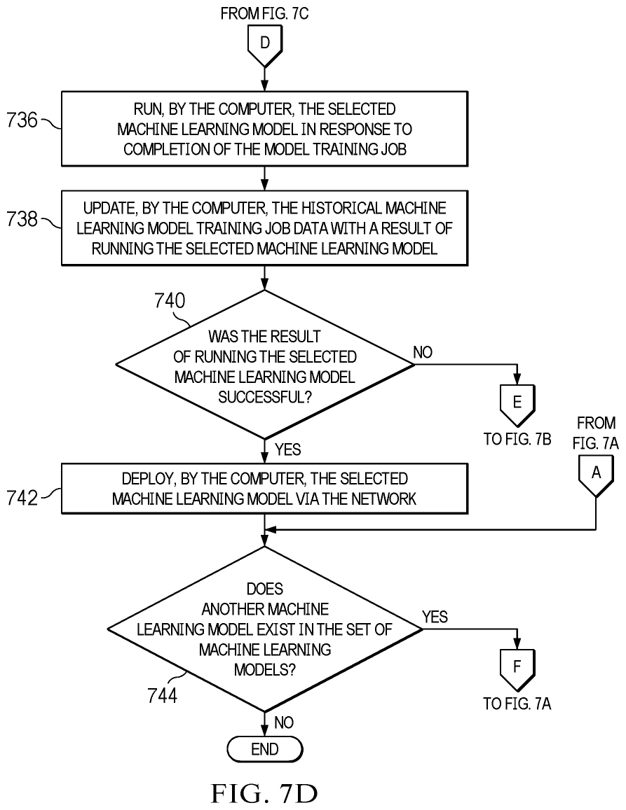

With reference now to FIGS. 7A-7D, a flowchart illustrating a process for automatically building a machine leaning model training environment runtime is shown in accordance with an illustrative embodiment. The process shown in FIGS. 7A-7D may be implemented in a computer, such as, for example, computer 101 in FIG. 1 or computer 202 in FIGS. 2A-2B. For example, the process shown in FIGS. 7A-7D may be implemented in model training environment building code 200 in FIG. 1.

The process begins when the computer receives an input to train a set of machine learning models from a client device corresponding to a user via a network (step 702). In response to receiving the input, the computer selects a machine learning model of the set of machine learning models to form a selected machine learning model to be trained (step 704).

The computer makes a determination as to whether the user selected automatic machine learning model training environment runtime build (step 706). If the computer determines that the user did not select automatic machine learning model training environment runtime build, no output of step 706, then the computer trains the selected machine learning model utilizing a standard model training process (step 708). Thereafter, the process proceeds to step 744. If the computer determines that the user did select automatic machine learning model training environment runtime build, yes output of step 706, then the computer builds a classification model for the selected machine learning model to be trained utilizing historical machine learning model training data that include both successful and failed previous running results corresponding to the selected machine learning model (step 710). Further, the computer builds a regression model for the selected machine learning model to be trained utilizing historical machine learning model training job data that include only successful previous running results corresponding to the selected machine learning model (step 712).

The computer determines a plurality of different combinations of input data set properties, settings of the selected machine learning model, and machine learning model training environment runtime properties (step 714). The computer inputs the plurality of different combinations of input data set properties, settings of the selected machine learning model, and machine learning model training environment runtime properties into the classification model (step 716). The computer runs the classification model with the plurality of different combinations of input data set properties, settings of the selected machine learning model, and machine learning model training environment runtime properties to predict a model training result of the selected machine learning model for each respective combination of the plurality of different combinations (step 718).

The computer makes a determination as to whether the classification model returned any predicted successful model training results (step 720). If the computer determines that the classification model did not return any predicted successful model training results, no output of step 720, then the computer performs a set of adjustments on at least one of the input data set properties, the settings of the selected machine learning model, or the machine learning model training environment runtime properties (step 722). Afterward, the computer reruns the classification model with the set of adjustments to the at least one of the input data set properties, the settings of the selected machine learning model, or the machine learning model training environment runtime properties (step 724). Thereafter, the process returns to step 720 where the computer determines whether any predicted successful model training results are returned.

Returning again to step 720, if the computer determines that the classification model did return one or more predicted successful model training results, yes output of step 720, then the computer selects only those combinations of the plurality of different combinations of input data set properties, settings of the selected machine learning model, and machine learning model training environment runtime properties that have a predicted successful model training result to form a set of selected combinations of input data set properties, settings of the selected machine learning model, and machine learning model training environment runtime properties having predicted successful model training results for the selected machine learning model (step 726). The computer runs the regression model with the set of selected combinations of input data set properties, settings of the selected machine learning model, and machine learning model training environment runtime properties having predicted successful model training results to predict a model training duration of the selected machine learning model for each respective combination of the set of selected combinations (step 728).

The computer calculates a capacity unit hours value for each respective combination of the set of selected combinations of input data set properties, settings of the selected machine learning model, and machine learning model training environment runtime properties having predicted successful model training results based on predicted model training duration of the selected machine learning model for each respective combination of the set of selected combinations (step 730). The computer selects a particular combination of the set of selected combinations of input data set properties, settings of the selected machine learning model, and machine learning model training environment runtime properties that has a lowest calculated capacity unit hours value (step 732).

The computer runs a model training job on the selected machine learning model using the particular combination of the set of selected combinations of input data set properties, settings of the selected machine learning model, and machine learning model training environment runtime properties having the lowest calculated capacity unit hours value (step 734). Then, the computer runs the selected machine learning model in response to completion of the model training job (step 736). Further, the computer updates the historical machine learning model training job data with a result of running the selected machine learning model (step 738).

The computer makes a determination as to whether the result of running the selected machine learning model was successful (step 740). If the computer determines that the result of running the selected machine learning model was not successful, no output of step 740, then the process returns to step 722 where the computer performs a set of adjustments. If the computer determines that the result of running the selected machine learning model was successful, yes output of step 740, then the computer deploys the selected machine learning model via the network (step 742).

Subsequently, the computer makes a determination as to whether another machine learning model exists in the set of machine learning models (step 744). If the computer determines that another machine learning model does exist in the set of machine learning models, yes output of step 744, the process returns to step 704 where the computer selects another machine learning model from the set of machine learning models. If the computer determines that another machine learning model does not exist in the set of machine learning models, no output of step 744, then the process terminates thereafter.

Thus, illustrative embodiments of the present invention provide a computer-implemented method, computer system, and computer program product for automatically building an efficient machine learning model training environment runtime in a cloud. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
predicting, by a computer, a model training result of a machine learning model utilizing a classification model based on a plurality of different combinations of input data set properties, settings of the machine learning model, and machine learning model training environment properties;
predicting, by the computer, model training duration of the machine learning model utilizing a regression model based on only those combinations of input data set properties, settings of the machine learning model, and machine learning model training environment properties that had a predicted successful model training result by the classification model;
determining, by the computer, capacity unit hours for each respective combination of input data set properties, settings of the machine learning model, and machine learning model training environment properties having the predicted successful model training result based on a corresponding predicted model training duration of the machine learning model;
selecting, by the computer, a particular combination of input data set properties, settings of the machine learning model, and machine learning model training environment properties that has determined minimum capacity unit hours; and
training, by the computer, the machine learning model using the particular combination of input data set properties, settings of the machine learning model, and machine learning model training environment properties that has the determined minimum capacity unit hours.

2. The computer-implemented method of claim 1 further comprising:
rebuilding, by the computer, the classification model and the regression model based on data collected from running the machine learning model after training to increase predictive accuracy of the classification model and the regression model.

3. The computer-implemented method of claim 1 further comprising:
building, by the computer, the classification model for the machine learning model utilizing historical machine learning model training data that include successful and failed previous running results corresponding to the machine learning model; and
building, by the computer, the regression model for the machine learning model utilizing historical machine learning model training job data that include only successful previous running results corresponding to the machine learning model.

4. The computer-implemented method of claim 1 further comprising:
determining, by the computer, the plurality of different combinations of input data set properties, settings of the machine learning model, and machine learning model training environment properties;
inputting, by the computer, the plurality of different combinations of input data set properties, settings of the machine learning model, and machine learning model training environment properties into the classification model;
running, by the computer, the classification model with the plurality of different combinations of input data set properties, settings of the machine learning model, and machine learning model training environment properties to predict the model training result of the machine learning model for each respective combination of the plurality of different combinations; and
determining, by the computer, whether the classification model returned any predicted successful model training results.

5. The computer-implemented method of claim 4 further comprising:
responsive to the computer determining that the classification model did not return any predicted successful model training results, performing, by the computer, a set of adjustments on at least one of the input data set properties, the settings of the machine learning model, or the machine learning model training environment properties; and
rerunning, by the computer, the classification model with the set of adjustments to the at least one of the input data set properties, the settings of the machine learning model, or the machine learning model training environment properties.

6. The computer-implemented method of claim 4 further comprising:
responsive to the computer determining that the classification model did return one or more predicted successful model training results, selecting, by the computer, only those combinations of the plurality of different combinations of input data set properties, settings of the machine learning model, and machine learning model training environment properties that have a predicted successful model training result to form a set of selected combinations of input data set properties, settings of the machine learning model, and machine learning model training environment properties having predicted successful model training results for the machine learning model; and
running, by the computer, the regression model with the set of selected combinations of input data set properties, settings of the machine learning model, and machine learning model training environment runtime properties having predicted successful model training results to predict the model training duration of the machine learning model for each respective combination of the set of selected combinations.

7. The computer-implemented method of claim 6 further comprising:
calculating, by the computer, a capacity unit hours value for each respective combination of the set of selected combinations of input data set properties, settings of the machine learning model, and machine learning model training environment properties having predicted successful model training results based on predicted model training duration of the machine learning model for each respective combination of the set of selected combinations;
selecting, by the computer, a particular combination of the set of selected combinations of input data set properties, settings of the machine learning model, and machine learning model training environment properties that has a lowest calculated capacity unit hours value; and
running, by the computer, a model training job on the machine learning model using the particular combination of the set of selected combinations of input data set properties, settings of the machine learning model, and machine learning model training environment properties having the lowest calculated capacity unit hours value.

8. The computer-implemented method of claim 7 further comprising:
running, by the computer, the machine learning model in response to completion of the model training job; and
updating, by the computer, historical machine learning model training job data with a result of running the machine learning model.

9. The computer-implemented method of claim 8 further comprising:
determining, by the computer, whether the result of running the machine learning model was successful; and
responsive to the computer determining that the result of running the machine learning model was successful, deploying, by the computer, the machine learning model.

10. A computer system comprising:
a communication fabric;
a storage device connected to the communication fabric, wherein the storage device stores program instructions; and
a processor connected to the communication fabric, wherein the processor executes the program instructions to:
predict a model training result of a machine learning model utilizing a classification model based on a plurality of different combinations of input data set properties, settings of the machine learning model, and machine learning model training environment properties;
predict model training duration of the machine learning model utilizing a regression model based on only those combinations of input data set properties, settings of the machine learning model, and machine learning model training environment properties that had a predicted successful model training result by the classification model;
determine capacity unit hours for each respective combination of input data set properties, settings of the machine learning model, and machine learning model training environment properties having the predicted successful model training result based on a corresponding predicted model training duration of the machine learning model;
select a particular combination of input data set properties, settings of the machine learning model, and machine learning model training environment properties that has determined minimum capacity unit hours; and
train the machine learning model using the particular combination of input data set properties, settings of the machine learning model, and machine learning model training environment properties that has the determined minimum capacity unit hours.

11. The computer system of claim 10, wherein the processor further executes the program instructions to:
rebuild the classification model and the regression model based on data collected from running the machine learning model after training to increase predictive accuracy of the classification model and the regression model.

12. The computer system of claim 10, wherein the processor further executes the program instructions to:
build the classification model for the machine learning model utilizing historical machine learning model training data that include successful and failed previous running results corresponding to the machine learning model; and
build the regression model for the machine learning model utilizing historical machine learning model training job data that include only successful previous running results corresponding to the machine learning model.

13. The computer system of claim 10, wherein the processor further executes the program instructions to:
determine the plurality of different combinations of input data set properties, settings of the machine learning model, and machine learning model training environment properties;
input the plurality of different combinations of input data set properties, settings of the machine learning model, and machine learning model training environment properties into the classification model;
run the classification model with the plurality of different combinations of input data set properties, settings of the machine learning model, and machine learning model training environment properties to predict the model training result of the machine learning model for each respective combination of the plurality of different combinations; and
determine whether the classification model returned any predicted successful model training results.

14. A computer program product comprising a computer-readable storage medium having program instructions embodied therewith, the program instructions executable by a computer to cause the computer to perform a method of:
predicting, by the computer, a model training result of a machine learning model utilizing a classification model based on a plurality of different combinations of input data set properties, settings of the machine learning model, and machine learning model training environment properties;
predicting, by the computer, model training duration of the machine learning model utilizing a regression model based on only those combinations of input data set properties, settings of the machine learning model, and machine learning model training environment properties that had a predicted successful model training result by the classification model;
determining, by the computer, capacity unit hours for each respective combination of input data set properties, settings of the machine learning model, and machine learning model training environment properties having the predicted successful model training result based on a corresponding predicted model training duration of the machine learning model;
selecting, by the computer, a particular combination of input data set properties, settings of the machine learning model, and machine learning model training environment properties that has determined minimum capacity unit hours; and
training, by the computer, the machine learning model using the particular combination of input data set properties, settings of the machine learning model, and machine learning model training environment properties that has the determined minimum capacity unit hours.

15. The computer program product of claim 14 further comprising:
rebuilding, by the computer, the classification model and the regression model based on data collected from running the machine learning model after training to increase predictive accuracy of the classification model and the regression model.

16. The computer program product of claim 14 further comprising:
building, by the computer, the classification model for the machine learning model utilizing historical machine learning model training data that include successful and failed previous running results corresponding to the machine learning model; and
building, by the computer, the regression model for the machine learning model utilizing historical machine learning model training job data that include only successful previous running results corresponding to the machine learning model.

17. The computer program product of claim 14 further comprising:
determining, by the computer, the plurality of different combinations of input data set properties, settings of the machine learning model, and machine learning model training environment properties;
inputting, by the computer, the plurality of different combinations of input data set properties, settings of the machine learning model, and machine learning model training environment properties into the classification model;
running, by the computer, the classification model with the plurality of different combinations of input data set properties, settings of the machine learning model, and machine learning model training environment properties to predict the model training result of the machine learning model for each respective combination of the plurality of different combinations; and
determining, by the computer, whether the classification model returned any predicted successful model training results.

18. The computer program product of claim 17 further comprising:
responsive to the computer determining that the classification model did not return any predicted successful model training results, performing, by the computer, a set of adjustments on at least one of the input data set properties, the settings of the machine learning model, or the machine learning model training environment properties; and
rerunning, by the computer, the classification model with the set of adjustments to the at least one of the input data set properties, the settings of the machine learning model, or the machine learning model training environment properties.

19. The computer program product of claim 17 further comprising:
responsive to the computer determining that the classification model did return one or more predicted successful model training results, selecting, by the computer, only those combinations of the plurality of different combinations of input data set properties, settings of the machine learning model, and machine learning model training environment properties that have a predicted successful model training result to form a set of selected combinations of input data set properties, settings of the machine learning model, and machine learning model training environment properties having predicted successful model training results for the machine learning model; and
running, by the computer, the regression model with the set of selected combinations of input data set properties, settings of the machine learning model, and machine learning model training environment runtime properties having predicted successful model training results to predict the model training duration of the machine learning model for each respective combination of the set of selected combinations.

20. The computer program product of claim 19 further comprising:
calculating, by the computer, a capacity unit hours value for each respective combination of the set of selected combinations of input data set properties, settings of the machine learning model, and machine learning model training environment properties having predicted successful model training results based on predicted model training duration of the machine learning model for each respective combination of the set of selected combinations;
selecting, by the computer, a particular combination of the set of selected combinations of input data set properties, settings of the machine learning model, and machine learning model training environment properties that has a lowest calculated capacity unit hours value; and
running, by the computer, a model training job on the machine learning model using the particular combination of the set of selected combinations of input data set properties, settings of the machine learning model, and machine learning model training environment properties having the lowest calculated capacity unit hours value.
